(19) United States
(12) Patent Application Publication
(10) Pub. No.: US 2007/0087234 A1
(43) Pub. Date: Apr. 19, 2007

(54) Dual-pump anode system with circulating liquid for direct oxidation fuel cells

(76) Inventors: Chao-Yang Wang, State College, PA (US); Fuqiang Liu, State College, PA (US); Yuusuke Sato, Tokyo (JP); Eiichi Sakaue, Tokyo (JP)

Correspondence Address: DLA PIPER US LLP;ATTN: PATENT GROUP, 1200 NINETEENTH STREET, NW, WASHINGTON, DC, 20036, US

(21) Appl. No.: 11/251,763

(22) Filed: Oct. 18, 2005

(51) Int. Cl. H01M 8/04

(52) U.S. Cl. 429/15; 429/34; 429/17

(57) ABSTRACT

A direct oxidation fuel cell anode system includes an anode; a circulation loop in fluid communication with the anode and including a circulation pump, the circulation pump being configured to circulate a circulating liquid in the circulation loop; a fuel cartridge; and a fuel pump in fluid communication with the circulation loop and the fuel cartridge, the fuel pump being configured to inject a fuel from the fuel cartridge into the circulating liquid, wherein the anode system is configured to accept no water from a cathode exhaust.

### BACKGROUND

1. Field

This invention relates generally to electrochemical fuel cells that generate electricity for portable power.

2. Discussion of the Background

A direct oxidation fuel cell (DOFC) is an electrochemical device that generates electricity from complete electro-oxidation of a liquid fuel. The liquid fuel of interest typically includes methanol, formic acid, dimethyl ether (DME), and their aqueous solutions. The oxidant may be substantially pure oxygen or a dilute stream such as that in air. Significant advantages of employing a DOFC in portable and mobile applications (e.g. notebook computers, mobile phones, PDAs, etc.) include easy storage/handling and high energy density of the liquid fuel.

One example of a DOFC system is a direct methanol fuel cell or DMFC. A DMFC generally employs a membrane-electrode assembly (hereinafter, “MEA”) having an anode, a cathode, and a proton-conducting membrane electrolyte put therebetween. A typical example of the membrane electrolyte is Nafion® (Nafion(® is a registered trademark of E.I. Dupont de Nemours and Company). Methanol/water solution is directly supplied to the anode as the fuel and air is supplied to the cathode as the oxidant. On the anode, methanol reacts with water in the presence of typically Pt-Ru catalysts to produce carbon dioxide, protons and electrons. That is,
CH_{3 l OH+H}₂O→CO₂+6H⁺+6e⁻ (1)

The protons migrate to the cathode through the proton conducting membrane electrolyte, which is non-conductive to electrons. The electrons travel to the cathode through an external circuit where electric power is delivered. On the cathode, the protons, electrons and oxygen molecules from air are combined to form water, namely
3/2O₂ +6H⁺+6e⁻→3H₂ O (2)

These two electrochemical reactions form an overall cell reaction as:
CH₃OH+3/20₂→CO₂+2H₂O (3)

In general, in a DMFC the methanol partly permeates the membrane electrolyte from the anode to the cathode and such methanol is called “crossover methanol”. The crossover methanol reacts with oxygen at the cathode, causing reduction in fuel utilization efficiency and cathode potential so that power generation of the fuel cell is suppressed. In addition, there exists large water crossover through the membrane driven by electroosmotic drag and diffusion, resulting in significant water loss from the anode. It is thus conventional for DMFC systems to use excessively dilute (3-6% by vol.) methanol solution in the anode in order to: (1) limit methanol crossover and hence its detrimental consequences, and (2) supply sufficient water to sustain excessive water crossover to the cathode through the membrane. However, the problem with such a DMFC system is that it requires a significant amount of water to be carried in a portable system, thus sacrificing the system energy density.

Some conventional systems recover water from the cathode exhaust and recycle it to the anode (U.S. Pat. No. 5,599,638). Liquid water transport in gas diffusion layers of polymer electrolyte fuel cells is discussed in U. Pasaogullari and C. Y. Wang, J. Electrochem. Soc., Vol. 151, pp.A399-A406, March 2004.

### BRIEF SUMMARY

A direct oxidation fuel cell dual pump anode system includes an anode; a circulation loop and a circulation pump for circulating liquid in the circulation loop; a fuel cartridge; and a fuel pump for injecting a fuel from the fuel cartridge into the circulating liquid. The anode system is configured to accept no water from a cathode exhaust.

### BRIEF DESCRIPTION OF THE FIGURES

FIG. 1 schematically illustrates a dual-pump anode system of a direct methanol fuel cell operating directly on high concentration fuel. The molarity (M) denotes the methanol concentration in the solution.

FIG. 2 illustrates a functional relationship between fuel flowrate and concentration in methanol, circulating liquid flowrate and concentration in methanol, and the feed rate and concentration to a DMFC.

FIG. 3 schematically illustrates an embodiment of a dual-pump anode system.

FIG. 4 schematically illustrates another embodiment of a dual-pump anode system.

FIG. 5 shows a voltage curve of 12 cm² cell discharged at 175 mA/cm² during a 6-hr test with 10M fuel feed, and its comparison with a reference cell.

### DETAILED DESCRIPTION OF SEVERAL EMBODIMENTS

DMFC technology is competing with advanced batteries such as lithium-ion batteries. The inventors have found that ability to use high concentration fuel at the anode is desirable for portable power sources, such as DMFCs.

One embodiment provides a dual-pump anode system that enables a direct oxidation fuel cell to operate directly on high concentration fuel from a cartridge, including neat methanol, without the recovery of water from the cathode exhaust. Another embodiment provides a direct oxidation fuel cell that retains optimal performance using high concentration fuel in a cartridge and elevated cell temperature.

One embodiment provides an electrochemical fuel cell that generates electricity for portable power. Another embodiment provides a direct methanol fuel cell that operates on high concentration fuel without the recovery or recycling or reuse of water from the cathode exhaust. Another embodiment includes a fuel cell having a dual-pump anode system in which water produced at the cathode is not recovered or recycled but rather is discarded from the cathode exhaust.

When water is not recovered from the cathode exhaust, the maximum allowable concentration of fuel from a fuel cartridge is determined by water and methanol losses from the anode compartment. The molar rate of methanol loss from the anode is represented by:

$${N}_{C H 3 O H} = ( 1 + β ) \frac{I}{6 F} \qquad ( 4 )$$

where β is the ratio of crossover methanol to methanol consumed for power generation, and F is Faraday's constant. “1” on the right hand side of Equation (4) represents one mole of methanol consumed in the anode catalyst layer for power generation, i.e. to produce the current density I. Similarly, the molar rate of water loss from the anode is given by:

$${N}_{H 2 O} = ( 1 + 6 α ) \frac{I}{6 F} \qquad ( 5 )$$

where α is a number of water molecules per proton penetrating the electrolyte membrane or commonly known as the net water transport coefficient through the membrane. “1” described in the bracket corresponds to one mole of water consumed in the anodic reaction (1). The molar ratio of methanol to water supplied to the anode is thus equal to:
N_{CH3OH}: N_{H2O}=(1β):(1+6α) (6)

In one embodiment, β is controlled to be less than 0.25 in order to maintain the fuel efficiency higher than 80%. Therefore, the fuel concentration equivalently given by the molar ratio is solely depending upon the water crossover coefficient α, according to Equation (6). For example, for β=0.25 (80% fuel efficiency) and α=0.4, Equation (6) yields a molarity of 11.2M in the fuel cartridge. Table 1 lists a one-to-one correspondence between the maximum allowable concentration (in M) in the fuel cartridge and the membrane water crossover coefficient α assuming the membrane methanol crossover coefficient β=0.25. Thus, achieving α low a is one key to using high concentration fuel in DMFCs.

βmay range from 0 to 1, which includes 0,0.1,0.15,0.2,0.25, 0.3,0.35,0.4, 0.45, 0.5, 0.6, 0.7, 0.8, 0.9, or 1, any non-integer value therebetween, or any combination thereof. Over this range of β, fuel efficiency may range from 50 to 100%, which includes 50, 55, 60, 65, 70, 75, 80, 85, 90, 95, 99, substantially 100, or 100%, any value, including non-integer value, therebetween, or any combination thereof. In one embodiment, β is controlled to be 0.25 or less in order to maintain the fuel efficiency of 80% or higher. In one embodiment, the fuel efficiency is 80% or higher.

Table 1 below shows te relationship between fuel molarity (moles of methanol in a methanol/water solution) and water crossover coeffiecient α through the membrane for β=0.25:

| Molarity (M) | CH3OH/H2O molar ratio | α |
|---|---|---|
| 1 | 0.02 | 10.94 |
| 2 | 0.04 | 5.15 |
| 3 | 0.06 | 2.55 |
| 4 | 0.09 | 2.26 |
| 5 | 0.11 | 1.68 |
| 6 | 0.14 | 1.29 |
| 8 | 0.21 | 0.81 |
| 10 | 0.30 | 0.52 |
| 12 | 0.42 | 0.33 |
| 15 | 0.69 | 0.14 |
| 17 | 0.98 | 0.05 |
| 18.245 | 1.25 | 0.00 |
| neat MeOH | infinite | −0.167 |

Recently, low-α MEAs have been made possible by two principal methods. One is to utilize liquid water backflow through a thin Nafion® membrane as described in U.S. patent application Ser. No. 11/013,922, filed Dec. 17, 2004, the entire contents of which are hereby incorporated by reference. In this approach α=0.4 at 60° C. has been demonstrated by using a highly hydrophobic microporous layer in an air-circulating cathode and a thin membrane (e.g. Nafion® 112) (C. Lim and C. Y. Wang, “High Performance Electrode Fabrication for Direct Methanol Fuel Cells,” Paper No.200 presented at 201^{st} Electrochemical Society Meeting, May 12-17, 2002, Philadelphia; and C. Lim and C. Y. Wang, “Development of High-Power Electrodes for a Liquid-Feed Direct Methanol Fuel Cell,” Journal of Power Sources 113, pp.145-150. January 2003; the entire contents of each of which are hereby incorporated by reference). The other possibility to obtain low-α is to use hydrocarbon membranes. For example, α=1.3 was demonstrated for sulfonated poly(arylene ether benzonitrile) membranes (Y. S. Kim, M. J. Sumner, W. L. Harrison, J. S. Riffle, J. E. McGrath, and B. S. Pivovar, Direct Methanol Fuel Cell Performance of Disulfonated Poly(arylene ether benzonitrile) Copolymers, J. Electrochem. Soc., Vol. 151, pp. A2157-A2172, Dec 2004, the entire contents of which are hereby incorporated by reference).

Unfortunately, having a low-α MEA without more does not permit direct feed of high concentration fuel into the anode, as described by equation (6). This is because direct feed of high concentration fuel in the anode, while satisfying the methanol and water balances, results in two detrimental consequences: (1) increased methanol crossover due to a larger methanol concentration gradient across the membrane, and (2) excessive methanol vapor loss through the CO₂ emission due to much higher methanol vapor saturation pressure from a highly concentrated liquid fuel. One embodiment provides a dual-pump anode with a circulating fluid to solve these problems and thus enable the direct use of high concentration fuel as specified by equation (6).

One embodiment provides a dual-pump anode with a circulating fluid, wherein the total methanol and water rates injected into the circulation loop have a ratio ranging from 0.02 to 1.25 for β=0.25, as seen in Table 1, which includes 0.02, 0.03, 0.04, 0,05, 0.06, 0.07, 0.08, 0.09, 0.1, 0.2, 0.3, 0.4, 0.5, 0.6, 0.7, 0.8, 0.9, 1.0, 1.1, 1.2, and 1.25, and any non-integer value therebetween. In one embodiment, the ratio is greater than 0.3.

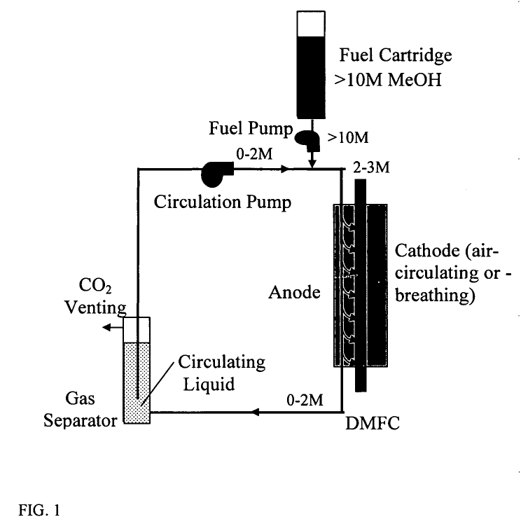

FIG. 1 schematically illustrates such a direct oxidation fuel cell system with two pumps on the anode side. In accordance with one embodiment, FIG. 1 shows methanol as the fuel in the system. However, other fuels, such as liquid carbonaceous fuels, are also suitable. In one embodiment, the fuel is an oxygenated fuel. In another embodiment, the fuel has no C-C bonds. In another embodiment, the fuel is methanol, formic acid, dimethyl ether, aqueous methanol solution, aqueous formic acid solution, aqueous dimethyl ether solution, or a mixture thereof, or a combination thereof, etc.

In one embodiment, the fuel is a high concentration fuel. The high concentration fuel may have a concentration ranging from about 10 to 24 M, which range includes 10, 11, 12, 13, 14, 15, 16, 17, 18, 19, 20, 21, 22, 23, or 24 M, or any value, including any non-integer value, therebetween. In one embodiment, the fuel is 30% by weight of methanol in an aqueous methanol solution. In another embodiment, the fuel is pure or substantially pure methanol.

In one embodiment, as shown in FIG. 1, the dual-pump anode system includes a circulation loop, a gas separator where CO₂ gas is vented, a circulation pump, and a fuel pump that injects high concentration fuel. The circulation loop connects the anode outlet with the anode inlet. The fuel cell includes the anode, cathode, and a proton-conducting electrolyte membrane. The anode, cathode and membrane are preferably a multi-layered structure referred to as an MEA. The gas separator vents CO₂ gas from the anode exhaust.

In one embodiment, a small amount of a liquid is initially stored in the circulation loop, referred to as the circulating fluid. The circulating fluid serves as a carrier liquid and, in one embodiment, is not created or consumed by the operation of the fuel cell. In one embodiment, the circulating fluid does not take part in the anode reaction. In one embodiment, the circulating fluid does not permeate through the membrane. In one embodiment, the circulating fluid does take part in the anode reaction. In one embodiment, the circulating fluid permeates through the membrane. In one embodiment, the amount of circulating fluid is maintained at a constant or substantially constant level. In one embodiment, the circulating fluid takes part in the anode reaction, and the amount of circulating fluid is maintained at a constant or substantially constant level. In one embodiment, the circulating fluid permeates through the membrane, and the amount of circulating fluid is maintained at a constant or substantially constant level. The circulating fluid can be pure water, or dilute water-methanol solution, or an aqueous methanol solution containing a third liquid. In one embodiment, the third liquid is miscible with methanol and water. In another embodiment, the third liquid is less volatile and electrochemically less active than methanol on the anode catalysts. In another embodiment, the third liquid does not absorb on or poison the anode catalysts. In another embodiment, the third liquid has large molecules to be difficult to permeate through the membrane electrolyte. Suitable non-limiting examples of the third liquid include dimethyl sulfoxide, ethanol, sulfuric acid, triflic acid, acetic acid, 5% Nafion® solution, polar solvent, highly polar solvent with high boiling point, or a combination thereof.

In one embodiment, high concentration fuel from the fuel cartridge is injected into the circulation loop near the anode inlet by a fuel pump. The rate of the fuel pump is controlled such that the methanol and water from the fuel cartridge match with their rates of loss in the anode either by the anodic reaction or crossover through the membrane to the cathode side according to equations (4) and (5). Hence, the anode exhaust returns to the original compositions of the circulating fluid. Throughout the circulation loop, the circulating fluid remains at its initial compositions except for the portion inside the anode where it is enriched with fuel by injection of high concentration fuel at the anode inlet and then depleted in fuel by anode consumption. In one embodiment, the circulating liquid provides a background fluid to dilute the fuel from the fuel cartridge such that fuel crossover in the fuel cell and fuel evaporation into the anode gas emissions are minimized. The anode exhaust is returned to a gas separator where CO₂ gas is vented and the liquid re-enters the circulation pump. To prevent small gas bubbles present in the gas separator from being entrained in the circulation pump and entering in the anode to cause spontaneous fuel starvation and hence cell voltage fluctuation, a porous thin-film filter may optionally be used at the intake of the circulation pump.

One advantage of the present dual-pump anode system with a circulating liquid is that the fuel pump is controlled to inject the precise amount of methanol and water required by equations (4) and (5), while the circulation pump can be independently controlled to facilitate CO₂ removal from the anode and hence optimize the cell performance. Therefore, both needs of a DMFC for use of high concentration fuel and optimized cell performance can be met simultaneously by this system with the two pumps actively and independently controlled.

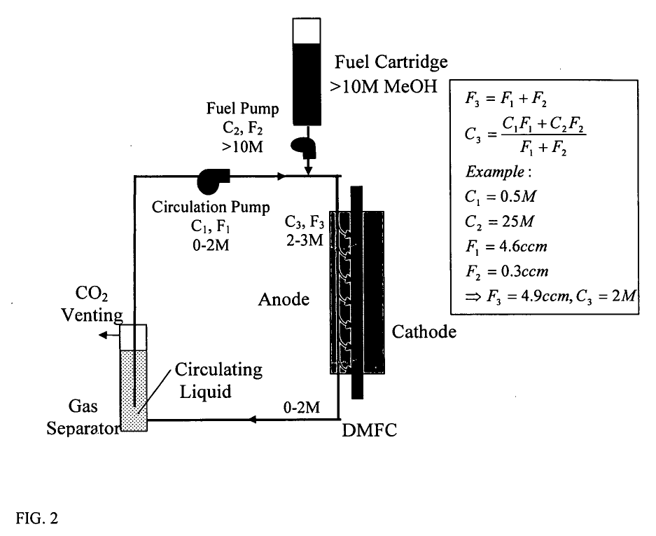

The functional relationship between the fuel injection pumping rate and circulation pumping rate can be mathematically expressed as:
F₁+F₂=F₃
C₁F₁+C₂F₂=C₃F₃ (7)
where F₁, F₂, and F₃ are the flow rates of circulating liquid, fuel from the fuel cartridge, and total liquid feed into the anode of a DMFC, respectively, as shown in FIG. 2. Similarly C₁, C₂, and C₃ are the methanol concentrations in the circulating liquid, fuel cartridge, and the total liquid feed into the DMFC anode, respectively. The values of C₃ and F₃ are determined by the optimal conditions required to produce the best cell performance. The values of C₂ and F₂ are determined by the reactant amounts as required by Equations (4) and (5). From Equation (7), one can then determine C₁ and F₁.

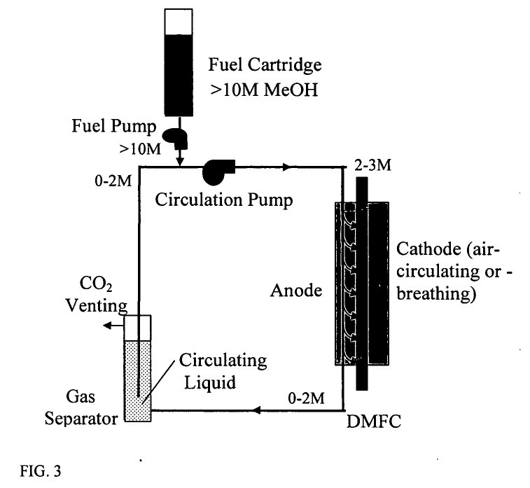

In one embodiment, shown in FIG. 3, a dual-pump anode system is provided wherein the fuel injection point is before the circulation pump such that the fuel from the fuel cartridge can be well mixed with the circulating liquid through the circulation pumping.

Alternatively, high concentration fuel from the fuel cartridge can be injected by the fuel pump perpendicularly to the face of anode plate like a shower through a porous structure. Such a face feed creates a uniform methanol concentration throughout the anode flow path and may provide advantages in certain applications.

At the start of operating the fuel cell, a small initial charge of circulating liquid with little water may be contained inside the gas separator. Alternatively, there can be no initial charge of water. Upon starting the fuel cell from a temperature lower than the design point or operating temperature (e.g. 45-60° C.), the water crossover coefficient through the membrane is initially lower due to lower cell temperatures. Hence, there will be water surplus in the anode exhaust initially and this surplus will be kept in the gas separator to form the circulating liquid. Once the DMFC temperature reaches the design point, there is no more surplus water in the anode exhaust and the liquid amount in the circulation loop ceases to increase.

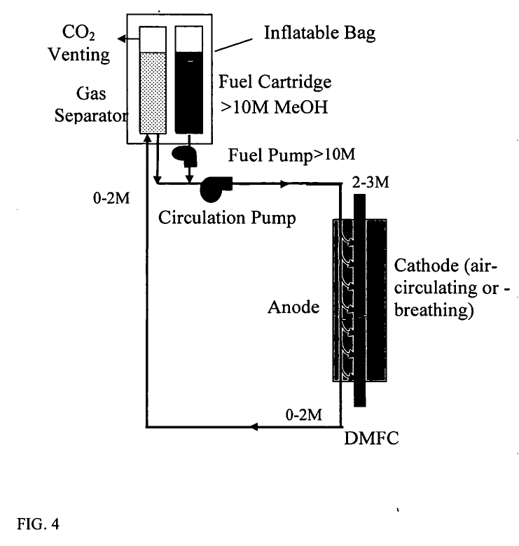

In one embodiment, the gas separator can be housed with fuel cartridge in an inflatable bag, for example, a plastic bag, as shown in FIG. 4. In one embodiment, the fuel cartridge can be initially full of fuel, such as high concentration methanol fuel, while the gas separator is deflated. Upon operation of the system, fuel is gradually consumed, the fuel cartridge becomes smaller, and the gas separator grows in size as it collects water and dilute fuel from the circulation loop. In one embodiment, the CO₂ gas separated by the gas separator is vented to the outside of the bag. As such, during system operation, the gas separator occupies a greater part of the interior of the bag and the fuel cartridge occupies a smaller part. This embodiment eliminates or minimizes the space requirement of the gas separator in the system.

The proton-conducting electrolyte membrane in the system shown in FIG. 1 can be either fluorinated membranes or hydrocarbon membranes. The lower the a value that can be achieved with a membrane, the higher the concentration of fuel can be used, according to equation (6).

The cathode side can be either air circulating or air breathing. No water recovery from the cathode side is necessary.

In one embodiment, the fuel cell provides from 100 mW to 100 W of power, which range includes 100, 200, 300, 400, 500, 600, 700, 800, or 900 mW, 1, 2, 3, 4, 5, 6, 7, 8, 9, 10, 15, 20, 25, 30, 35, 40, 45, 50, 60, 70, 80, 90, or 100 W, or any value, including any non-integer value, therebetween or any combination thereof.

The fuel cell is suitable as a power source for any electronic device, for example, as a battery replacement, supplement, or back up. Some non-limiting examples of electronic devices include computers, personal digital assistants, cell phones, cameras, digital cameras, portable music devices, handheld game devices, and the like.

### EXAMPLES

The following examples are provided for illustration purposes only and are not intended to be limiting unless otherwise specified.

An experiment was conducted in which a cell having a 12 cm² active area was used, the cathode gas diffusion layer (hereinafter, “GDL”) included a carbon cloth GDL of 300 μm in thickness and a 30 μm thick microporous layer (MPL). The anode backing layer was a Toray carbon paper TGPH 090 with the thickness of 260 μm. The MEA was made by hot-pressing the anode backing layer and cathode GDL onto a catalyst coated Nafion® 112 membrane. The loading of Pt—Ru (Pt—Ru black HiSPEC 6000, Pt:Ru=1:1 atomic ratio, Alfa Aesar, a Johnson Matthey Company) on the anode and Pt (supported on carbon 40% Pt/Vulcan XC72 from E-TEK) was 4.6 mg/cm² and 1.2 mg/cm², respectively. The MEA was installed in a conventional cell fixture with two-pass serpentine flowfield, and the cell was operated in the same setup as shown in FIG. 1.

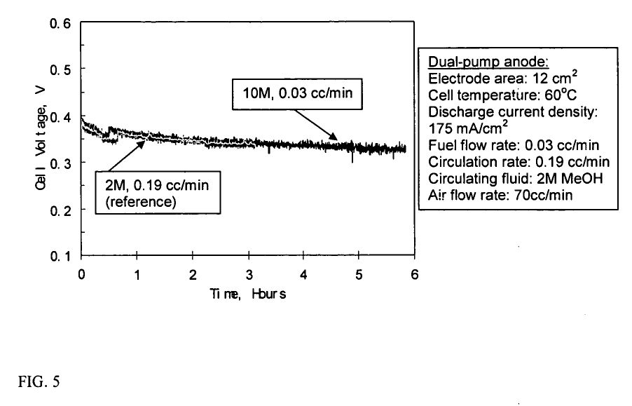

FIG. 5 shows the voltage curve of the 12 cm² cell discharged at 175 mA/cm² while feeding with 10M methanol fuel. The fuel feeding rate was 30 μl/min, the anode circulation rate was 190 μl/min, and the cathode air flow rate was set at 70 cc/min. Compared to a reference cell performance operated constantly at 2M and under otherwise identical conditions, an example cell produced similarly high performance. In addition, the example cell can operate stably during the 6-hour test.

Several embodiments discussed herein make it possible to use concentrated fuel with no recovery of water from the cathode exhaust and match the optimized cell performance with diluted methanol. It should be noted that the fuel feeding rate and air stoichiometry used may vary with cell operating conditions.

What is claimed is:

1. A direct oxidation fuel cell anode system, comprising:
an anode;
a circulation loop in fluid communication with the anode and comprising a circulation pump, the circulation pump being configured to circulate a circulating liquid in the circulation loop;
a fuel cartridge; and
a fuel pump in fluid communication with the circulation loop and the fuel cartridge, the fuel pump being configured to inject a fuel from the fuel cartridge into the circulating liquid;
wherein the anode system is configured to accept no water from a cathode exhaust.

2. The anode system of claim 1, wherein the circulation loop further comprises a gas separator.

3. The anode system of claim 2, wherein the gas separator is configured to separate CO₂ gas from the circulating liquid.

4. The anode system of claim 2, further comprising an inflatable bag, wherein the gas separator and the fuel cartridge are housed together in the inflatable bag.

5. The anode system of claim 1, wherein the circulation loop further comprises the circulating liquid.

6. The anode system of claim 5, wherein the circulating liquid comprises at least one fluid selected from the group consisting of water, aqueous fuel solution, dimethyl sulfoxide, ethanol, sulfuric acid, triflic acid, Nafion solution, polar solvent, or a mixture thereof.

7. The anode system of claim 1, wherein the fuel pump is configured to inject fuel into the circulating liquid upstream or downstream of the circulation pump.

8. The anode system of claim 1, wherein the anode comprises a surface, and wherein the fuel pump is configured to inject the fuel perpendicularly to the anode surface.

9. The anode system of claim 8, wherein the circulation loop further comprises a porous structure between the fuel pump and the anode surface, and wherein the fuel is injected through the porous structure perpendicularly to the anode surface.

10. The anode system of claim 1, wherein the fuel cartridge further comprises the fuel.

11. The anode system of claim 10, wherein the fuel is a liquid carbonaceous fuel or oxygenated fuel.

12. The anode system of claim 10, wherein the fuel comprises at least one fuel selected from the group consisting of methanol, aqueous methanol, formic acid, aqueous formic acid, dimethyl ether, aqueous dimethyl ether, or a combination thereof.

13. The anode system of claim 1, wherein a fuel concentration in the fuel cartridge is specified according to the following Equation (I):
N_{CH3OH}:N_{H2O}=(1+β): (1+6α) (I)
wherein N_{CH3OH} is the molar rate of methanol loss from the anode, N_{H2O} is the molar rate of water loss from the anode, β is the ratio of crossover methanol to methanol consumed in power generation, and α is the net water transport coefficient.

14. A direct oxidation fuel cell, comprising the anode system of claim 1; a cathode; and a proton-conducting membrane electrolyte between the anode and the cathode.

15. The fuel cell of claim 14, which is a direct methanol fuel cell.

16. The fuel cell of claim 14, which has a net water crossover from the anode to cathode of less than one water molecule per proton.

17. The fuel cell of claim 14, wherein the electrolyte membrane comprises a fluorinated or hydrocarbon polymer.

18. The fuel cell of claim 14, further comprising a cathode exhaust, wherein water produced at the cathode exhaust is not recovered.

19. An electronic device, comprising the fuel cell of claim 14.

20. A method, comprising generating electrical power with the fuel cell of claim 14.

21. The method of claim 20, further comprising injecting the fuel into the circulating liquid.

22. The method of claim 20, wherein the fuel comprises aqueous methanol and is injected at a rate to compensate with the loss of methanol and water from the anode.

23. The method of claim 20, further comprising producing water at the cathode, wherein the water is not recycled.
